(19) United States
(12) Patent Application Publication
(10) Pub. No.: US 2002/0091818 A1
(43) Pub. Date: Jul. 11, 2002

(54) Technique and tools for high-level rule-based customizable data extraction

(75) Inventors: Keith Girolamo Cascio, Bethesda, MD (US); John Gary Dudley, Raleigh, NC (US); Yongcheng Li, Raleigh, NC (US); Yih-Shin Tan, Raleigh, NC (US)

Correspondence Address: Jeanine S. Ray-Yarletts, IBM Corporation T81/503, PO Box 12195, Research Triangle Park, NC, 27709, US

(73) Assignee: International Business Machines Corporation, Armonk, NY (US)

(21) Appl. No.: 09/754,987

(22) Filed: Jan. 5, 2001

(51) Int. Cl. G06F 15/173; G06F 15/16

(52) U.S. Cl. 709/224; 709/233

(57) ABSTRACT

The present invention provides a method, system, and computer program product for extracting data from a data stream (including data streams that contain the presentation space for a legacy host screen) using a rule-based approach that does not require a user to write programming language statements. The disclosed techniques apply to presentation space data that is sent from a legacy host application to a workstation, as well as to other types of data streams (including data exchanged between applications, Web page data, etc.). Rules are defined using intuitive, interactive tools to specify the target patterns of data to be extracted. Tags in a markup language (such as the Extensible Markup Language, or “XML”) are defined, and are associated with the defined rules. Upon detecting a match between the data in an incoming data stream and a target rule, an output document (expressed in the markup language) is created. Use of the markup language document provides great flexibility, enabling the document to be translated or otherwise transformed for use in multiple different environments.

### BACKGROUND OF THE INVENTION

1. Field of the Invention

The present invention relates to a computer system, and deals more particularly with a method, system, and computer program product for extracting data from a data stream (including data streams that contain the presentation space for a legacy host screen) using a rule-based approach that does not require a user to write programming language statements.

2. Description of the Related Art

One of the challenges facing information services (“IS”) professionals today is the difficulty of integrating legacy mainframe host applications and data with modem computing environments and their modem user interfaces. In particular, it is necessary to extend the reach of many legacy applications such that they can be accessed through the Internet and in World Wide Web-enabled environments for business-to-business (“B2B”) and business-to-consumer (“B2C”) use. (The term “Web” is used hereinafter to refer to the World Wide Web as well as the Internet, for ease of reference.)

Most legacy host applications present their data in text-based user interfaces designed for use on specific, obsolete character-based terminals. The legacy applications were written with this character-based terminal presentation space as the only interface format in which the host data output is created, and in which host data input is expected. “Presentation space” is a term used abstractly to refer to the collection of information that together comprises the information to be displayed on a user interface screen, as well as the control data that conveys how and where that information is to be represented.

A typical character-based terminal is the IBM Model 327x from the International Business Machines Corporation (“IBM”). This terminal model was designed to display information in a matrix of characters, where the matrix typically consisted of 24 rows each having 80 columns. When programs were written expecting this display format, programmers would specify placement of information on the screen using specific row and column locations. Information formatted for this display is sent as a data stream to the mechanism in the display hardware that is responsible for actually displaying the screen contents. The phrase “data stream” refers to the fact that the data is sent as a linear string, or stream, of characters. This stream of characters contains both the actual textual information to be displayed on the screen as well as information specifying where and how the text is to be displayed. “Where” consists of the row and column where the text is to begin, and “how” consists of a limited number of presentation attributes such as what color (typically either green or white) to use when displaying that text, whether a field is protected (i.e. input-inhibited), etc. While the Model 327x is a specific type of IBM display hardware, data formatted for any display having similar characteristics became a de facto standard format referred to as a “3270 data stream”. Similarly, the IBM Model 525x is another type of character-based terminal. This terminal displays data in a slightly different manner from the IBM 327x, and consequently uses a different data stream format. The “5250 data stream” also became a de facto standard format for displays having similar characteristics. A third type of data stream format commonly used by legacy host applications is referred to simply as an “ASCII data stream” (or equivalently as a Virtual Terminal, or “VT”, data stream). While an ASCII data stream is not formatted for a specific model of display screen, a data stream in this format has certain predefined characteristics (for example, the manner in which a control character indicates the line spacing to be used).

The displays used with modern computer workstations (including personal computers, handheld computing devices, network computers, and other types of computers) support graphics and video, in addition to text characters. These displays do not use a character-based row and column matrix approach to screen layout. Instead, an application program in this environment has access to thousands of tiny display elements, allowing the various types of information to be placed virtually anywhere on the display screen.

When a modern computer workstation is used to access a legacy host application running on a mainframe or a server, the output data created by that host application is often still formatted as one of the character-based data stream formats. It is therefore necessary to somehow reformat the character-based data sent by the legacy application (using the presentation space for transferring data) for display on a modern display screen. This problem has been recognized for a number of years, and consequently, a number of products and techniques have been developed.

One way to reformat legacy host data is to rewrite the legacy applications. However, this is typically not a viable approach for a number of reasons (including lack of the required programming skills, the considerable time and expense that would be involved, lack of access to the legacy source code, etc.). In an alternative approach that is commonly used, a user interface facility executing on a modern workstation accepts the existing host presentation space format when retrieving data from the host application, but does not show the data to the user in this format. The user interface facility “scrapes” (that is, extracts) data from the host presentation space, reformats it (typically in an application-specific manner), and presents it to the user in a form that is appropriate for the display screen device used with the workstation. By convention, this form tends to be a graphical user interface (“GUI”) where information is presented in a window-based layout. The user then interacts with the application using this graphical user interface.

While a screen scraping approach avoids rewriting the legacy host application, it presents a new problem. Presentation spaces appear asynchronously in the data stream sent from the host application, so using the presentation space format as the expected format for user interface data becomes unpredictable. Whether it is due to network traffic, host application response time, etc., there is no set time when a presentation space will begin arriving from the host application, and no specific period of time in which the entire screen contents will be transmitted. Commonly-assigned U.S. Pat. No. ______ (Ser. No. 09/034,297, filed Mar. 4, 1998), which is titled “Host Application Presentation Space Recognition Producing Asynchronous Events”, defines a technique for automating host presentation space interaction. According to this invention, one or more presentation space definitions may be created, where each definition specifies information that will be present in a particular presentation space that may arrive from the legacy application. For each defined presentation space, a target software routine may be identified which embodies knowledge of how the presentation space is formatted and how the information contained in that presentation space is to be presented to the user. The data stream coming from the host is constantly monitored to see if one of the defined presentation spaces appears. When a defined presentation space does appear, the associated target software routine is asynchronously invoked for processing the data contained in that presentation space.

Commonly-assigned U.S. Pat. No. ______ (Ser. No. 09/531,239, filed Mar. 21, 2000), which is titled “Optimizing Host Application Presentation Space Recognition Events Through Matching Prioritization”, defines a technique for automated host presentation space recognition that improves system performance if the number of presentation space definitions is very large. For those companies which have been using legacy host applications extensively for many years, there may be hundreds or even thousands of screens which are sent by legacy applications to user workstation software. The techniques disclosed in this invention improve processing time and make the use of computing resources more efficient when the presentation space definitions take on this order of magnitude.

However, these inventions are directed towards recognizing data of interest, and do not deal with how the extracted data is made available. The disclosed techniques specify that programmer-written code is invoked to process extracted data. To maximize use of extracted data in modem computing environments for B2B and B2C applications, it would be preferable if the extracted data could be provided in an easily extensible format, such that it would be usable in a variety of environments without requiring environment-specific programming. One extensible format that is quite popular today is the Extensible Markup Language, or “XW”. The second of these U.S. Patents (U.S. Pat. No. ______, Ser. No. 09/531,239) discusses use of XML documents for persisting presentation space definitions. However, there is no discussion of using XML documents for extracted data.

Other existing approaches for integrating legacy applications into the Web environment include:

Writing code to extract the data. Examples of this approach include Host Access Class Library (“HACL”) applications and Attachmate® EXTRA!® client applications. HACL, a product of IBM, provides programming access to 3270, 5250, and Virtual Terminal data streams using an object-oriented interface. Attachmate EXTRA! software enables client applications to access enterprise host systems and their data. However, writing code is a tedious, low-level solution that is usable only by those with programming skills. (“Attachmate” and “EXTRA!” are registered trademarks of Attachmate Corporation.)

Use of software products for extracting strings and/or fields of information. Examples of this approach include IBM's Host On-Demand and Screen Customizer products. When using Host On-Demand, a macro is typically written that defines an application-specific sequence of host screen interactions and the necessary actions to navigate them. This information is captured and recorded to enable using the macros in an automated manner at a later time. As the macro is being created, a person such as a designer of the host application GUI will be asked to identify the location of the strings and fields of interest (e.g. on which panel(s) this information will be requested, and in what relative position within the data stream the information may be found). Screen Customizer may be used with Host On-Demand, and utilizes screen recognition technology to generate graphical representations from legacy host screens without writing programming statements. However, this approach can extract and generate simple data structures easily, but requires a significant amount of effort to get useful data for more complex data components (such as tables and lists).

Extraction using a knowledge base. An example of this approach is the Jacada® product line, which uses a knowledge base of more than 700 pre-defined rules to convert host screen data into a GUI representation. However, systems of this type are typically quite expensive (exceeding $20,000) and often require a user to make many selections from a large rules base before finding the right rule. Furthermore, expanding the Jacada rules base requires specially trained and certified consultants. (“Jacada” is a registered trademark of Jacada Ltd.)

Component extraction using hard-coded heuristics. Commonly-assigned U.S. Pat. No. ______ (Ser. No. 09/353,218, filed Jul. 14, 1999), which is titled “Methods, Systems, and Computer Program Products For Applying Styles to Host Screens Based on Host Screen Content”, which is hereby incorporated herein by reference, discloses a technique for generating high-level complex data components in an extensible format by simple selection. However, the disclosed technique does not specify details about how to customize and add new heuristics to augment system provided heuristics.

Accordingly, what is needed is an improved technique for extracting complex data components from legacy host screen data or presentation spaces. The technique should provide an efficient, easy-to-use solution that can be used by those without programming skills and which is easily customizable, and which makes the extracted data available in an easily extensible format such that it can be used in a variety of environments without requiring environment-specific programming.

### SUMMARY OF THE INVENTION

An object of the present invention is to provide an improved technique for extracting complex data components from legacy host screen data or presentation spaces.

A further object of the present invention is to provide an improved technique for extracting complex data components from structured data such as XML documents.

Another object of the present invention is to provide this technique in an efficient, easy-to-use manner that can be used by those without programming skills.

A further object of the present invention is to provide this technique through tools which automatically generate code to enforce extraction specifications from high-level rules.

Yet another object of the present invention is to provide a technique for writing the data extracted through use of the rules as output in extensible markup language documents.

Other objects and advantages of the present invention will be set forth in part in the description and in the drawings which follow and, in part, will be obvious from the description or may be learned by practice of the invention.

To achieve the foregoing objects, and in accordance with the purpose of the invention as broadly described herein, the present invention provides a method, system, and computer program product for extracting data from a data stream and writing the extracted data to one or more output documents. This technique comprises: defining one or more data extraction rules, each of the rules comprising one or more rule components; defining one or more output document templates for storing extracted data, wherein each of the templates comprises one or more tags which are hierarchically structured and wherein each template is to be associated with one or more of the data extraction rules; associating at least one of the templates with at least one of the rules; storing the rules, the templates, and the associations; monitoring at least one data stream for arrival of incoming data; comparing the incoming data to selected ones of the stored rules until detecting a matching rule; extracting data from the incoming data, upon detecting the matching rule, according to the matching rule; and storing the extracted data in an extensible document which is created according to the tags and structure of a selected one of the templates that is associated with the matching rule.

The associations preferably associate the rule components of a particular rule with the tags of a particular template. The technique may further comprise transforming the extracted data in the extensible document into another notation, or transforming the extracted data in the extensible document into another format. The extensible document may be, for example, an XML document.

The components of selected ones of the rules may specify~ textual patterns, data element and attribute patterns, and/or a combination of textual patterns and data element and attribute patterns.

Typically, the data stream will be a legacy host stream containing one or more presentation spaces, a data stream that is sent between peer applications, or a data stream containing one or more Web pages.

The present invention will now be described with reference to the following drawings, in which like reference numbers denote the same element throughout.

### BRIEF DESCRIPTION OF THE DRAWINGS

FIG. 1 is a block diagram of a computer workstation environment in which the present invention may be practiced;

FIG. 2 is a diagram of a networked computing environment in which the present invention may be practiced;

FIGS. 3-6 illustrate flow charts setting forth the logic which may be used to implement a preferred embodiment of the present invention;

FIG. 7 illustrates an example of the legacy host screens from which complex data components may be extracted, according to the present invention;

FIG. 8 illustrates a transformed screen resulting from reformatting the information extracted using the present invention;

FIG. 9 depicts a GUI screen that may be used when creating or modifying a rule, according to the present invention;

FIG. 10 illustrates an example of a markup language document that may be created upon detecting a match between a defined rule and an incoming data stream, according to the present invention; and

FIG. 11 depicts an example XML document which corresponds to the host screen in FIG. 7, and from which complex data components may be extracted directly, according to the present invention.

### DESCRIPTION OF THE PREFERRED EMBODIMENT

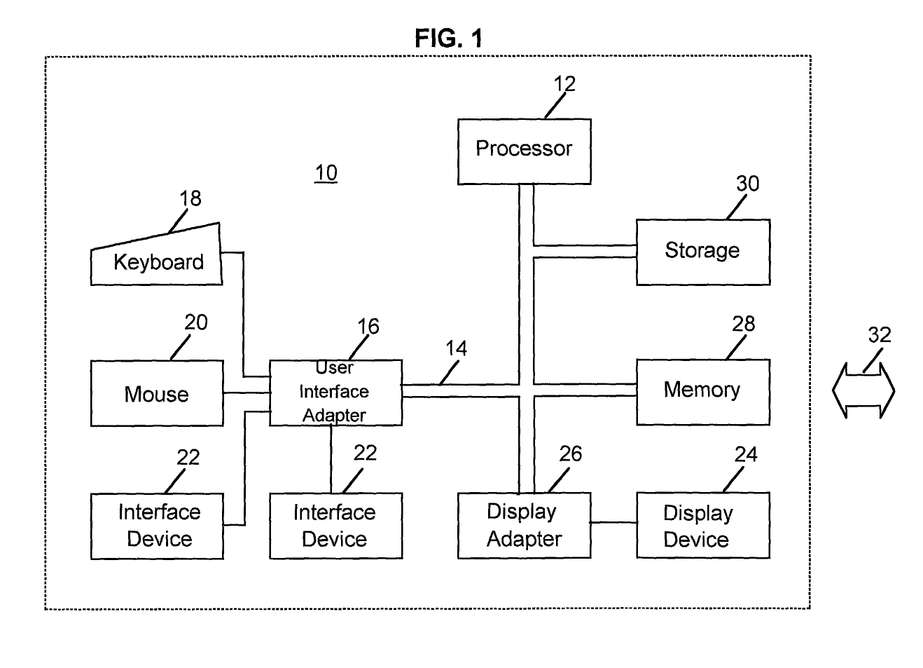

FIG. 1 illustrates a representative workstation hardware environment in which the present invention may be practiced. The environment of FIG. 1 comprises a representative single user computer workstation 10, such as a personal computer, including related peripheral devices. The workstation 10 includes a microprocessor 12 and a bus 14 employed to connect and enable communication between the microprocessor 12 and the components of the workstation 10 in accordance with known techniques. The workstation 10 typically includes a user interface adapter 16, which connects the microprocessor 12 via the bus 14 to one or more interface devices, such as a keyboard 18, mouse 20, and/or other interface devices 22, which can be any user interface device, such as a touch sensitive screen, digitized entry pad, etc. The bus 14 also connects a display device 24, such as an LCD screen or monitor, to the microprocessor 12 via a display adapter 26. The bus 14 also connects the microprocessor 12 to memory 28 and long-term storage 30 which can include a hard drive, diskette drive, tape drive, etc.

The workstation 10 may communicate with other computers or networks of computers, for example via a communications channel or modem 32. Alternatively, the workstation 10 may communicate using a wireless interface at 32, such as a CDPD (cellular digital packet data) card. The workstation 10 may be associated with such other computers in a LAN or a WAN, or the workstation 10 can be a client in a client/server arrangement with another computer, etc. All of these configurations, as well as the appropriate communications hardware and software, are known in the art.

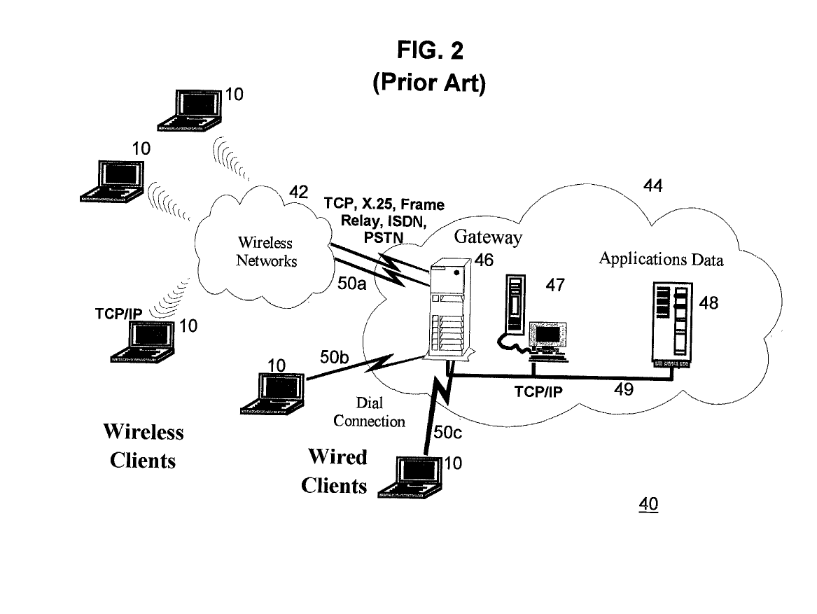

FIG. 2 illustrates a data processing network 40 in which the present invention may be practiced. The data processing network 40 may include a plurality of individual networks, such as wireless network 42 and network 44, each of which may include a plurality of individual workstations 10. Additionally, as those skilled in the art will appreciate, one or more LANs may be included (not shown), where a LAN may comprise a plurality of intelligent workstations coupled to a host processor.

Still referring to FIG. 2, the networks 42 and 44 may also include mainframe computers or servers, such as a gateway computer 46 or application server 47 (which may access a data repository 48). A gateway computer 46 serves as a point of entry into each network 44. The gateway 46 may be preferably coupled to another network 42 by means of a communications link 50a. The gateway 46 may also be directly coupled to one or more workstations 10 using a communications link 50b, 50c. The gateway computer 46 may be implemented utilizing an Enterprise Systems Architecture/370 available from IBM, an Enterprise Systems Architecture/390 etc. Depending on the application, a midrange computer, such as an Application System/400 (also known as an AS/400) may be employed. (“enterprise Systems Architecture/370” is a trademark of IBM; “Enterprise Systems Architecture/390” , “Application System/400”, and “AS/400” are registered trademarks of IBM.)

The gateway computer 46 may also be coupled 49 to a storage device (such as data repository 48). Further, the gateway 46 may be directly or indirectly coupled to one or more workstations 10.

Those skilled in the art will appreciate that the gateway computer 46 may be located a great geographic distance from the network 42, and similarly, the workstations 10 may be located a substantial distance from the networks 42 and 44. For example, the network 42 may be located in California, while the gateway 46 may be located in Texas, and one or more of the workstations 10 may be located in New York. The workstations 10 may connect to the wireless network 42 using a networking protocol such as the Transmission Control Protocol/Internet Protocol (“TCP/IP”) over a number of alternative connection media, such as cellular phone, radio frequency networks, satellite networks, etc. The wireless network 42 preferably connects to the gateway 46 using a network connection 50a such as TCP or UDP (User Datagram Protocol) over IP, X.25, Frame Relay, ISDN (Integrated Services Digital Network), PSTN (Public Switched Telephone Network), etc. The workstations 10 may alternatively connect directly to the gateway 46 using dial connections 50b or 50c. Further, the wireless network 42 and network 44 may connect to one or more other networks (not shown), in an analogous manner to that depicted in FIG. 2.

Software programming code which embodies the present invention is typically accessed by the microprocessor 12 of the workstation 10 (or server 47 or gateway 46) from long-term storage media 30 of some type, such as a CD-ROM drive or hard drive. The software programming code may be embodied on any of a variety of known media for use with a data processing system, such as a diskette, hard drive, or CD-ROM. The code may be distributed on such media, or may be distributed from the memory or storage of one computer system over a network of some type to other computer systems for use by such other systems. Alternatively, the programming code may be embodied in the memory 28, and accessed by the microprocessor 12 using the bus 14. The techniques and methods for embodying software programming code in memory, on physical media, and/or distributing software code via networks are well known and will not be further discussed herein.

A user of the present invention may connect his computer to a server using a wireline connection, or a wireless connection. Wireline connections are those that use physical media such as cables and telephone lines, whereas wireless connections use media such as satellite links, radio frequency waves, and infrared waves. Many connection techniques can be used with these various media, such as: using the computer's modem to establish a connection over a telephone line; using a LAN card such as Token Ring or Ethernet; using a cellular modem to establish a wireless connection; etc. The user's computer may be any type of computer processor, including laptop, handheld or mobile computers; vehicle-mounted devices; desktop computers; mainframe computers; etc., having processing and communication capabilities. The remote server, similarly, can be one of any number of different types of computer which have processing and communication capabilities. These techniques are well known in the art, and the hardware devices and software which enable their use are readily available. Hereinafter, the user's computer will be referred to equivalently as a “workstation”, “device”, or “computer”, and use of any of these terms or the term “server” refers to any of the types of computing devices described above.

The computing environment in which the present invention may be used includes an Internet environment, an intranet environment, an extranet environment, or any other type of networking environment. These environments may be structured using a client-server architecture, a multi-tiered architecture, or an alternative network architecture.

In the preferred embodiment, the present invention is implemented as one or more computer software programs. An implementation of the invention extracts data from a data stream (including data streams that contain the presentation space for a legacy host screen) using a rule-based approach that does not require a user to write programming language statements. The disclosed techniques apply to a data stream that is sent from a legacy host application to a workstation, as well as to other types of data streams (including data exchanged between peer applications, Web page data, etc.). Rules are defined using intuitive declarations, interactive tools or GUI screens to specify the target patterns of data to be extracted. Tags in a markup language (such as XML) are defined, and are associated with the defined rules. Upon detecting a match between the data in an incoming data stream and a target rule, an output document (expressed in the markup language) is created. Use of the markup language document to represent extracted data in a well-defined format serves as a conduit that provides great flexibility, enabling the document to be translated or otherwise transformed for use in multiple different environments. For example, if the extracted data is to be transmitted to a user who has a pervasive computing device (e.g. a handheld computing device), then the XML document containing the extracted data can be transformed into a WML (Wireless Markup Language) document for efficient transmission to, and processing by, this user. Or, it may be desirable to transform the extracted data from an XML document into an HTML (HyperText Markup Language) document for processing by a Web browser. Many other similar notational transformations may be performed from an extensible language document, and transformations other than from one notation to another may be performed as well (such as reformatting the extracted data, translating the extracted text into another natural language, etc.).

An implementation of the present invention may execute entirely on a user's computer or it may execute on a remote computer, such as a middle-tier server or gateway. Alternatively, the application may execute partly on the user's computer and partly on the remote computer. Preferably, the rule definition process executes on the user's computer, and the matching and extraction process that uses the defined rules executes either on the user's computer or on a remote computer. In the preferred embodiment, the invention is implemented using object-oriented programming languages and techniques. However, the invention may alternatively be implemented using conventional programming languages that are not object-oriented, without deviating from the inventive concepts.

The preferred embodiment is described herein primarily in terms of a 3270 data stream. However, the inventive concepts of the present invention are not limited to 3270 data stream formats: any data stream format may be equivalently used, where the data stream format is well-defined and has well-defined codes indicating the attribute types used in the data stream.

The present invention discloses a new technique for enabling users to extract data from data streams, and in particular, from legacy host data streams that contain presentation space data. The technique is efficient, easy to use, and flexible, and does not require the user who specifies the target data patterns to have programming skills.

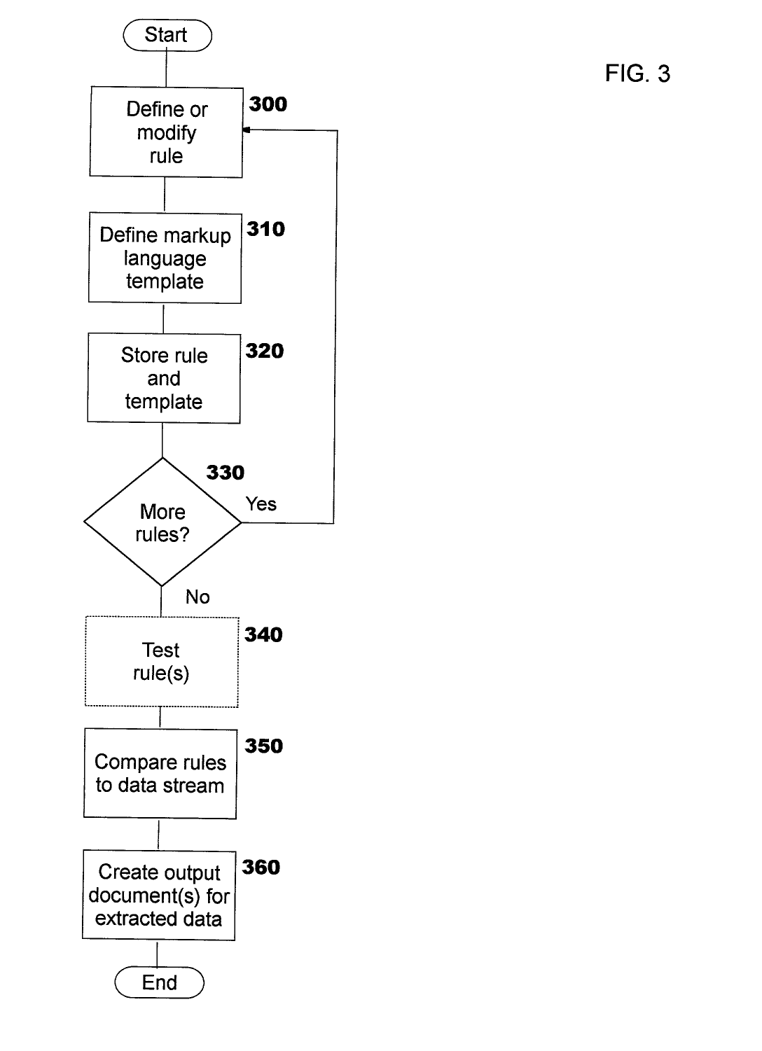

The preferred embodiment of the present invention will now be discussed with reference to FIGS. 3 through 11.

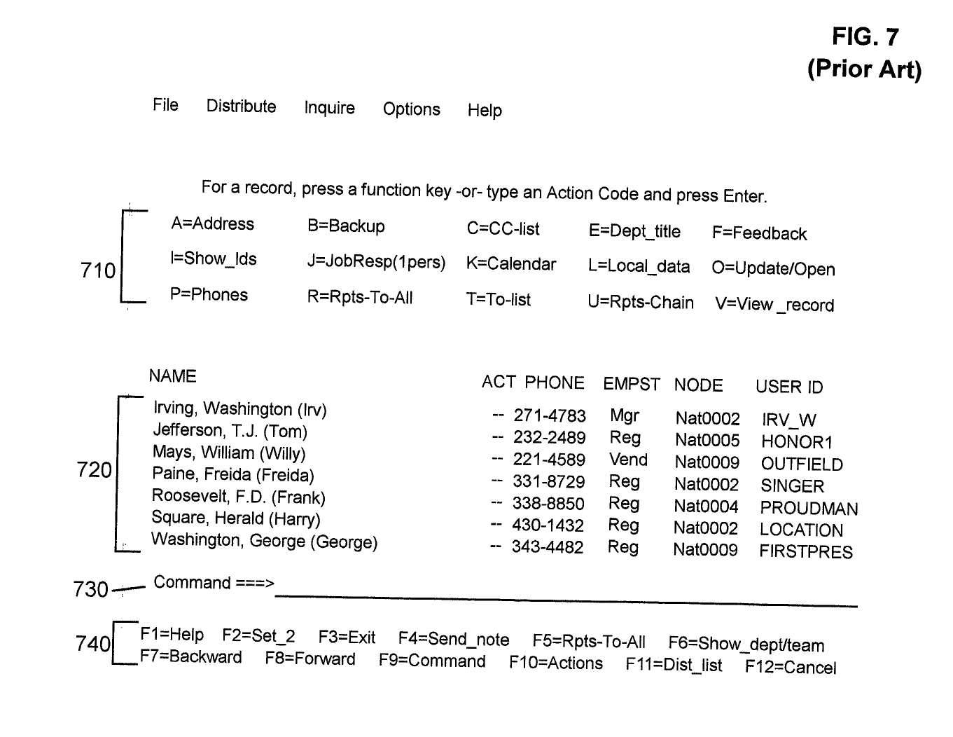

FIG. 3 depicts a high level view of the logic with which the preferred embodiment of the present invention operates, illustrating how the rule definition and extraction process occurs. As shown in Block 300, the user first defines (or modifies) a rule. The markup language tags to be used for storing a data component extracted according to this rule are then defined as a template for a markup document (Block 310). The rule is then stored in a rules base (Block 320). Information specifying the associated markup document may also be stored in this rules base, or it may be stored in a separate storage construct (such as a table or list). The test in Block 330 asks whether the user has more rules to define or modify. If so, control returns to Block 300; otherwise, processing continues at Block 340, which indicates that the user may optionally choose to test operation of one or more of the defined rules. (Alternatively, the user may test each rule during the creation/modification and storing operations.) When a data stream is received at run-time, Block 350 compares the defined rules in the rules base to the incoming data to see if a match is detected. (Alternatively, an implementation of the present invention may allow the user to explicitly specify the rule(s) to be applied to a particular data stream. For example, the user may be presented with a display screen of data from a legacy application, such as that shown in FIG. 7, and may then invoke application of a particular rule against the data on that display screen. Processing the incoming data will be described in more detail below.) Block 360 then creates one or more output documents in a markup language to represent the data that is extracted, according to a matching rule or rules, and preferably stores these output documents in persistent storage.

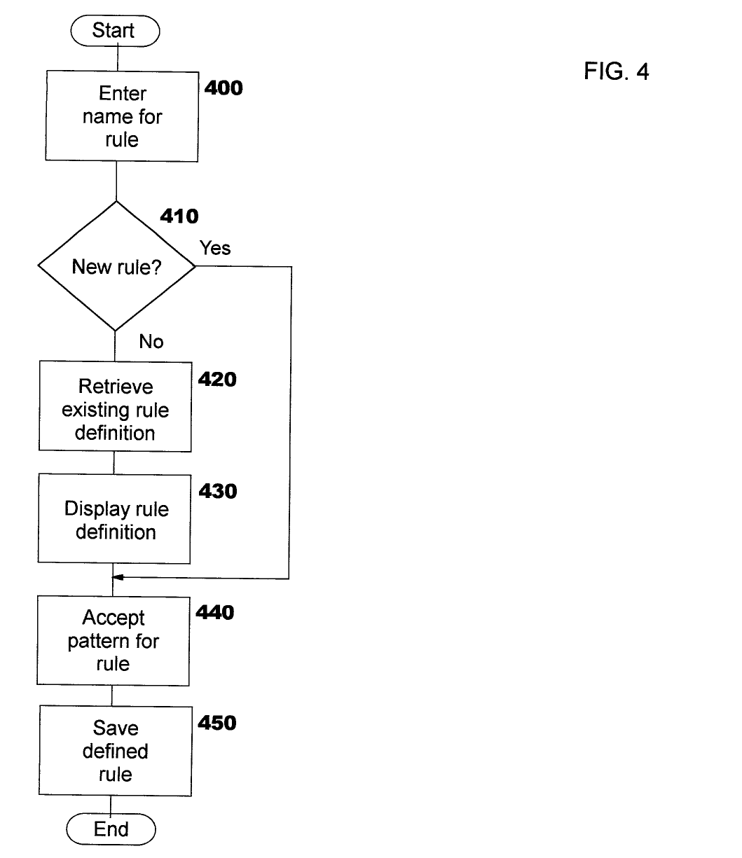

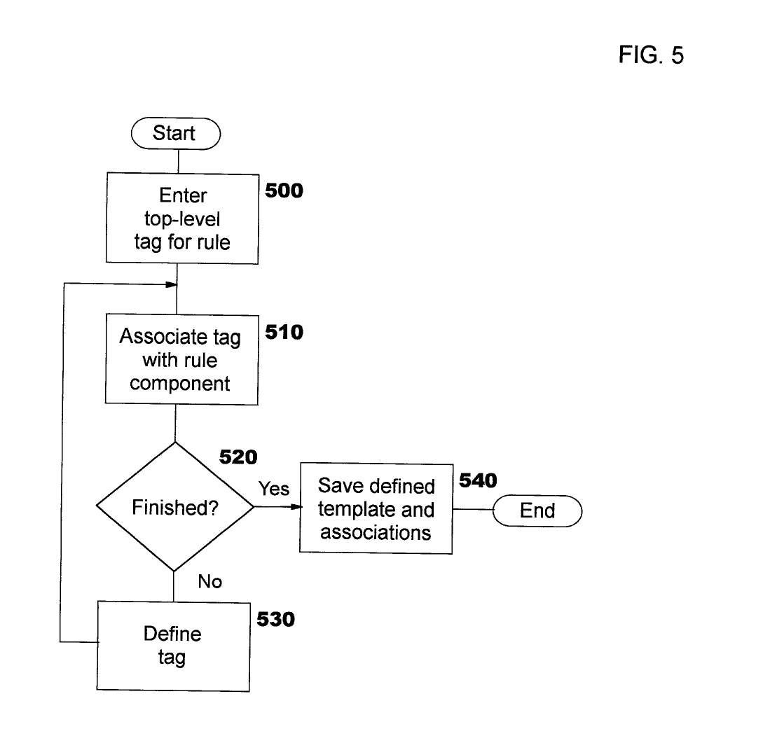

The process of creating or modifying a rule will now be described in more detail with reference to FIGS. 4 and 5. (Hereinafter, unless otherwise stated, the description will refer to creating a rule, for ease of reference; modifications are analogous, and simply apply to rules that are found in the rules base already.) The process begins with the user defining a data pattern for the rule. Then, the markup tags and document structure to be used for the data component(s) extracted using this rule are defined.

At Block 400, the user preferably defines a name for the rule. Use of a name enables storing and retrieving the rule definition (e.g. for subsequent revisions). As shown at Block 410, the user is preferably asked explicitly whether he would like to create a new rule or to modify an existing rule. If he chooses to modify an existing rule, then the name entered at Block 400 is used to retrieve the existing rule definition (Block 420). (If an existing rule by this name is not found in the rules base, then this is an error, and an appropriate error message should be displayed.) The retrieved definition is displayed (Block 430). After displaying the existing definition at Block 430, or when the user requests to create a new rule at Block 410, control reaches Block 440 where the user's input for defining the pattern of the rule is accepted.

A data pattern may be described using three types of elements. First, a text pattern may be specified using the regular expression language syntax that is in use for an implementation of the present invention, where the text pattern describes the target pattern of characters in the input data stream. For example, suppose the user wishes to extract the list of all function keys appearing on a legacy host screen, such as the screen in FIG. 7 (see element 740). Knowing that all of the function keys appear using the format “F”, followed by 1 or 2 digits, followed by “=” , then a textual name for the key (followed by blanks or whitespace characters), the user may construct a text pattern that will match all such function key occurrences. An example of the pattern may be:

“F”,digit+,“=”,string,space+where “F” (in quotations) indicates that the letter “F” occurs; “digit+” indicates that one or more digits occurs; “=” indicates that an equal sign occurs; “string” indicates that a text string occurs; and “space+” indicates the presence of one or more blanks or whitespace characters. (Commas have been used as delimiters between the parts of the expression in this example. This is for purpose of illustration: other delimiters may be used alternatively.)

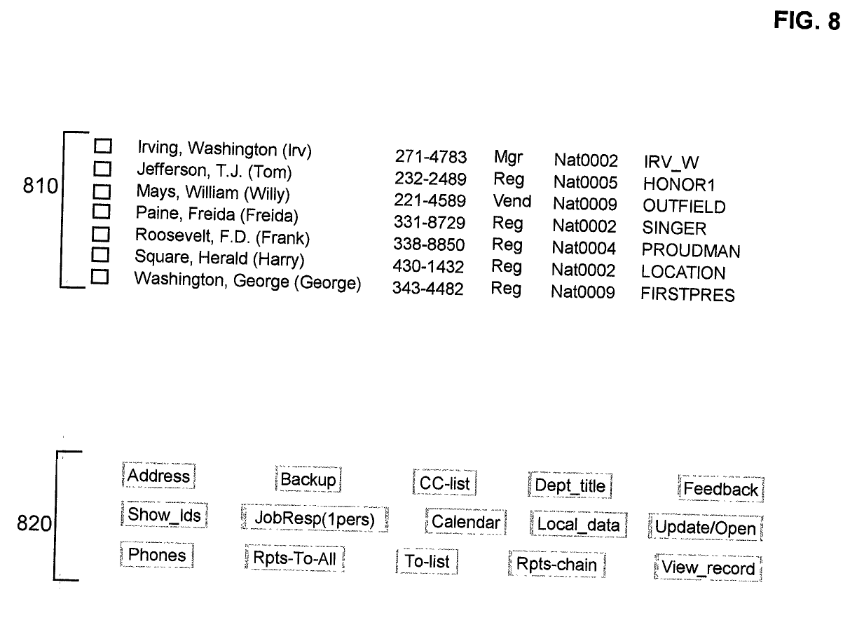

As a second way in which data patterns may be described, a data element and attributes pattern may be specified. As previously stated, a limited number of attribute types occur in legacy data streams, such as a color attribute, a protected or input-inhibited attribute, a reverse video attribute, and so forth. In an XML document, tags and attributes are used similarly. A pattern may therefore be constructed that will search for and match a particular set of data elements and attributes. Or, attribute patterns may specify the starting location (and, optionally, the ending location) of data of interest. For example, tables of data usually consist of fields with well-aligned positions. Element 720 of FIG. 7 contains a table of 7 rows, each row containing an employee name, phone number, employee status indicator, and a computer system identifier comprised of a system name and a user identifier. Element 710 shows a group of action codes, in which 15 different 1-character codes are associated with 15 actions that may be performed from a particular legacy host data screen. Using the techniques of the present invention, the table of employee information may be extracted for presentation on a modern GUI screen, and one or more of the action entries may be extracted, for example for presentation as buttons on the reformatted GUI screen. See FIG. 8 for an example of such a screen. The function keys shown at 740 could also be extracted and presented on the GUI screen, if desired, although this has not been shown in FIG. 8.

As a third way in which data patterns for incoming data may be described, a mixture of text and attribute patterns may be used. For example, the command line field of legacy host screens often contains the text “Command→” as an input-inhibited field, followed by a field in which input is allowed. See element 730 of FIG. 7 for an example. A pattern may be constructed to recognize the text as well as the attributes of the data element(s) in this command line. Other similar areas of a screen may be specified using this mixed text and attribute approach as well, for example by specifying the textual caption that appears before the input field.

Data patterns may be described in other ways such as relative occurrences of a sequence of data elements. Since the text pattern is described in regular expression language syntax, it should be able to cover most of the user's needs. In case new pattern types are needed, the present invention allows new pattern type descriptions by specifying the associated matching rules. It will then apply such rules when the data pattern is encountered.

Once the pattern for the rule has been entered at Block 440, it is preferably saved to the rules base (Block 450). The process of creating or modifying a rule then ends. The logic of FIG. 4 may be repeated as necessary for each rule to be created or modified.

As compared with prior art techniques, extracting complex components from legacy host screens is much easier with use of the present invention. As an example, rather than having to individually find and extract all 12 (or 24, in some cases) function keys that may appear on a screen such as those shown at 740 in FIG. 7, or all of the action codes shown at 710, or all of the rows of content shown at 720, the present invention allows the user to simply specify a generic pattern that will match and extract all such key or action definitions or all such rows. One way in which this information may be used after extraction is to present these extracted function key names, or the action code names, as text on buttons or other graphical elements of a GUI screen, as stated briefly above. FIG. 8 illustrates a simple GUI rendering of the data content of FIG. 7, where the action codes have been transformed in this manner (see element 820). The user then preferably applies an action to one (or more than one, if desired) of the names in the rows shown at 810 by clicking in the box to the left of the row, and then pressing an appropriate button from the selections shown at 820.

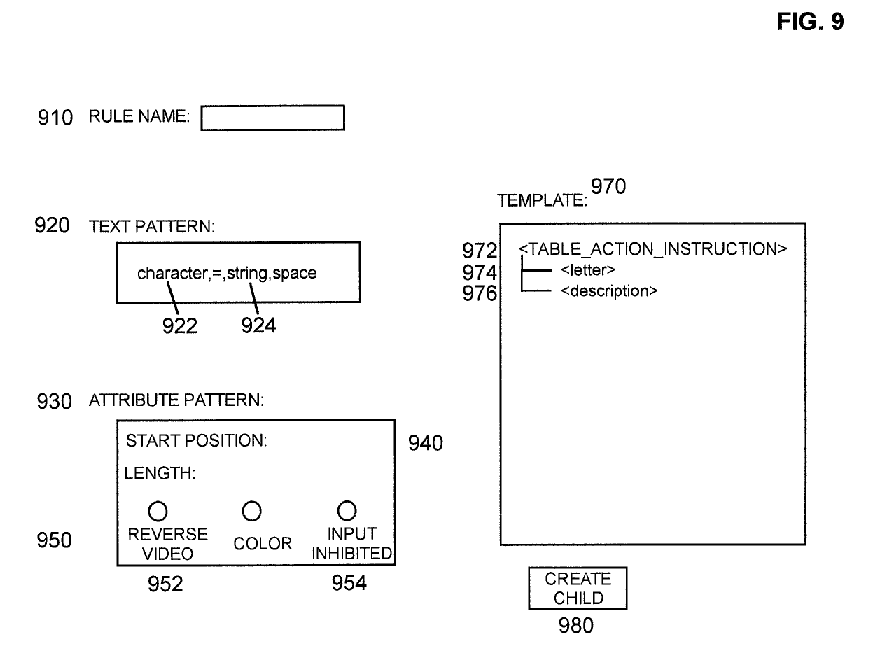

Preferably, a GUI such as that shown in FIG. 9 is used for enabling users to intuitively and interactively define or modify rules that will extract complex data components, as well as the format of markup language documents into which the extracted data will be written. With reference to the sample input GUI in FIG. 9, element 910 illustrates how an entry field for the rule name may be depicted. The area in which a textual pattern for a rule definition may be entered is shown generally at element 920. A textual rule is preferably defined using a regular expression grammar. Thus, the user may be presented with an entry area in which he can enter individual parts of the textual expression, including symbols to indicate when more than one character in the input data stream should be considered as a match for this pattern. As an example of a regular expression for use in matching the action codes shown at 710 in FIG. 7, the user may construct one of the following patterns:

character,=,string,space OR character,=,character+,space where “string” may be a special keyword that is used to denote occurrence of one or more characters. Equivalently, the presence of one or more characters may be indicated by the notation “character+”.

The area in which a pattern for matching an attribute may be entered is shown generally at element 930. Preferably, an attribute pattern is defined using a starting location and a length (as shown at 940), or by selecting from a predetermined set of attribute types (as shown at 950). As an example of an expression for use in matching a reverse video field, for example, the user preferably clicks on radio button 952.

Note that while the preferred embodiment is described with reference to defining text and attribute patterns using a GUI or tool that is specifically designed for this purpose, other techniques may be used alternatively, without deviating from the scope of the present invention. For example, a simple text editor may be used for specifying the text and attribute patterns. Furthermore, the layout shown in FIG. 9 is merely for illustrative purposes. Attribute patterns may be defined as applying across multiple data elements, although this has not been illustrated in the examples.

When a combination of text and attributes are used in a rule definition, the user preferably enters information both in area 920 and in area 930. For example, to match the command line shown at 730 in FIG. 7, the rule is preferably defined in area 920 using a textual pattern such as:

“Command”,=+,>,space

and an attribute type of input-inhibited (by selecting radio button 954). As illustrated in this example, quote marks may be used to surround a string value when that exact string is to be searched for in the input data stream, and a plus sign (“+”) may be used to indicate that more than one of a particular symbol may be considered as matching part of an expression. (Note that in this example, the symbols “=” and “>” have not been surrounded by quotation marks. In an alternative approach to specifying the rules, it may be desirable to surround such symbols with quotation marks. The specific rule syntax used in an embodiment of the present invention may vary without deviating from the inventive concepts disclosed herein.)

An extensible document is used to store data that is extracted from the input data stream upon matching the pattern in a particular rule. The user is preferably allowed to specify the tag names to be used in that document, as well as the hierarchical relationship among the tags. The area shown generally at 970 of FIG. 9 illustrates one format in which this information may be accepted. As shown in this example, the user selects a tag name of “Table_Action_Instruction” 972 for the highest level tag (for example, when retrieving the action codes shown at 710 of FIG. 7). (Angle bracket delimiters are shown surrounding the tag names in FIG. 9 for purposes of illustration only. While the generated extensible markup language document will typically use angle brackets for delimiters, it is not strictly necessary to show them to the user as he creates the template.)

After specifying a high-level tag name, the user then specifies (for this example) that this tag will have two child tags. The first has been given the name of“letter” in this example, and the second has been named “description”, as shown at 974 and 976, respectively.

The logic in the flowchart of FIG. 5 illustrates how the user preferably constructs the template for the markup language document. The name of a top-level element is specified (Block 500). At Block 510, the user associates this tag with some component of the defined rule. Typically, the top-level element corresponds to the entire rule. On subsequent iterations through Block 510, the tags for lower-level elements will typically be associated with individual components of the rule. For example, the tag <letter> shown at 974 may be associated with the rule component “character” shown at 922, while the tag <description> shown at 976 is associated with the rule component “string” shown at 924. Block 520 then checks to see if the definition is finished. If so, the defined template and the association information is preferably stored in persistent storage (Block 540), after which the processing of FIG. 5 ends for this template definition. Otherwise, another tag is defined (Block 530) by specifying a tag name and the hierarchical relationship of this tag within the template. Control then returns to Block 510 for associating this tag with a component of the rule. This process repeats until the template definition and specification of the associations is finished. A button such as that shown at element 980 in FIG. 9 may be used to enable the user to conveniently indicate the nesting relationships among the tag being defined.

In the preferred embodiment, the user is provided defaults to construct rules and corresponding templates for matching (at least) the following types of complex data components: tables, lists, table action instructions, table item indexes, command lines, and function keys. (A table action instruction is a set of action instructions, such as those shown at 710 in FIG. 7, that tells the user how to specify an input action for a legacy host screen. A table item index is used when a query returns more records than a legacy host screen can display. The table item index then indicates the current position within the result, such as “1 to 6 of 32”.) Predefined rules may be supplied for these types of complex data components, in which case a user may use the predefined rules as a starting point for creating a set of rule definitions tailored to his particular needs.

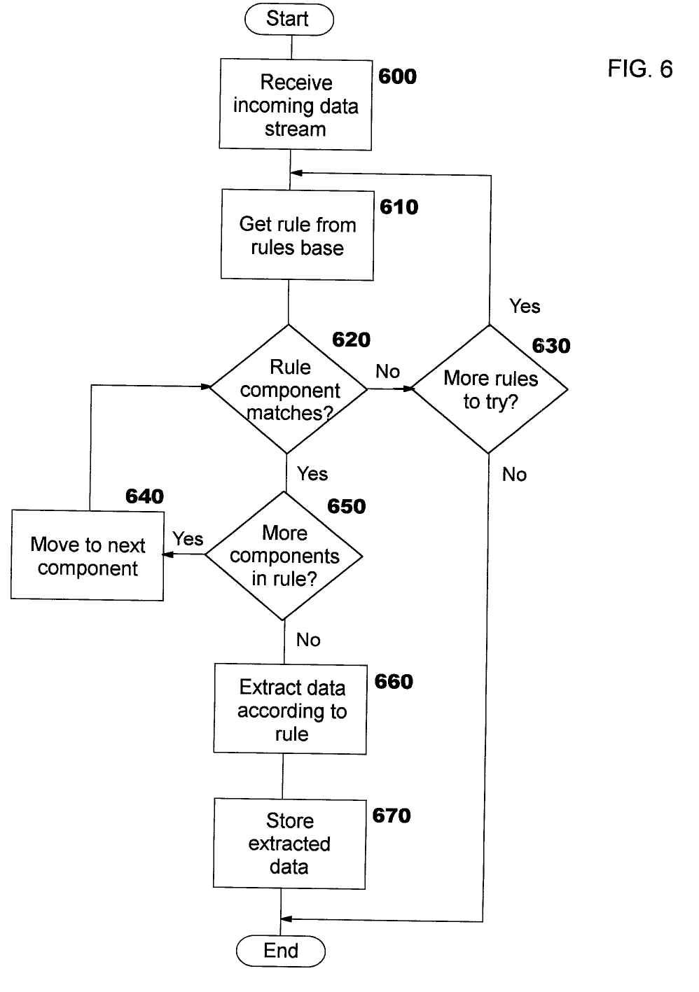

The manner in which the patterns in the rules are matched against incoming data streams will now be described. At Block 600, the incoming data stream is monitored for arrival of data. When data such as an XML document or a presentation space (or an appropriate portion thereof) arrives, Block 610 begins a process of comparing the rules in the rules base to the incoming data to see if any data is to be extracted. Block 610 thus retrieves a rule from the rules base. Block 620 then compares the current component of this rule (which is the first component on the first iteration through Block 620 for a particular rule, and a next component on subsequent iterations) to the received data. If this component does not match, then this is not a matching rule, and control transfers to Block 630. At Block 630, a test is made to see if there are more rules in the rules base to try to match. If so, control returns to Block 610 to get the next rule. Otherwise, when there are no more rules, then the processing of FIG. 6 ends for this incoming data.

When the test in Block 620 has a positive result (i.e. a component of the rule matches the incoming data), then Block 650 checks to see if the rule has more components. If it does not, then the rule has been completely matched, and processing continues at Block 660 where the data is extracted according to the extraction pattern defined in this rule. (Alternatively, portions of the data may be extracted as each component matches, although when a rule does not completely match, this alternative approach will lead to some wasted processing.) The extracted data is then stored (Block 670), after which the processing of the matching rule against the incoming data ends. (It may be desirable to check the incoming data for more than one matching rule. It will be obvious to one of ordinary skill in the art how the logic shown in FIG. 6 can be altered to provide this additional checking. For example, control may transfer from Block 670 back to Block 630 to get another rule and begin the comparison process for that rule.)

When the component that has just matched is not the final component in the rule, then it cannot yet be determined whether this is a matching rule. In this case, the test in Block 650 has a positive result, and control transfers to Block 640 to position to the next sequential component in the rule. Control then returns to Block 620 to test whether the component matches the incoming data.

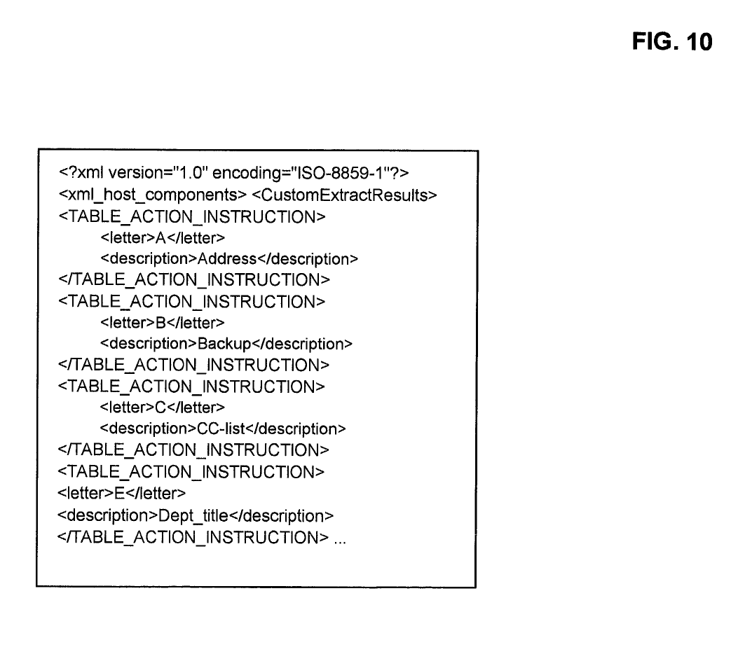

The sample markup language document in FIG. 10 illustrates extraction of the action codes from the area depicted as element 710 of FIG. 7. As shown in this example, the caption for the action keys in FIG. 7 are stored as values for the “description” tags, while the 1-letter action codes are stored as the values of the “letter” tags. With the extraction process of the present invention, the action codes of the example screen have been transformed from an unstructured data stream into well-formatted data which is ready for integration with other application input and/or transformation into another format for display or other processing. Since the prior art does not provide a convenient way to search for and extract data that appears to be unstructured but in reality is a set of action key or function key definitions, existing browser-based general purpose host application access software such as the HostPublisher Legacy XML Gateway (LXGW) from IBM typically provides a keypad on which all function key definitions for the application are represented, regardless of whether a particular screen uses all of the keys. With use of the present invention, on the other hand, the function keys that are designed to appear on each individual screen can be detected in the incoming data stream, and automatically extracted and presented on a transformed representation of the source screen.

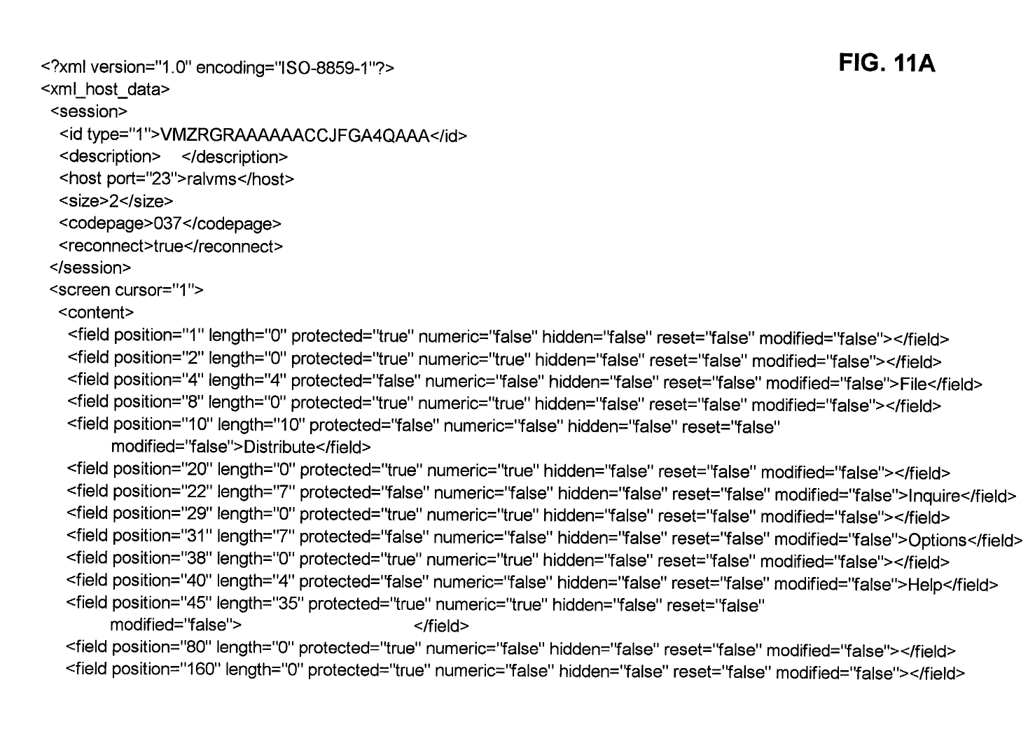

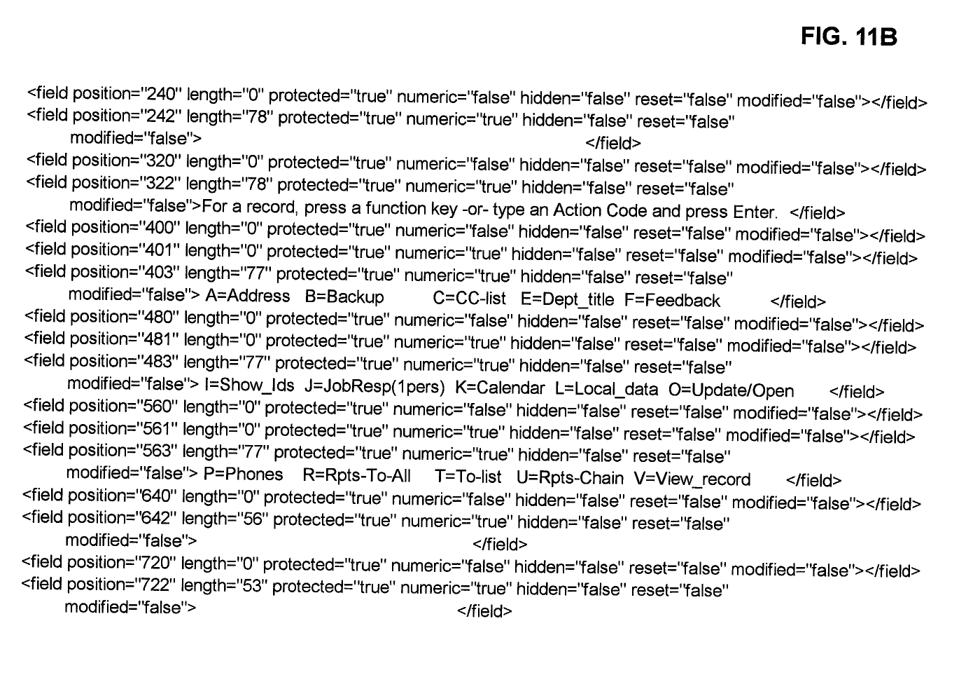

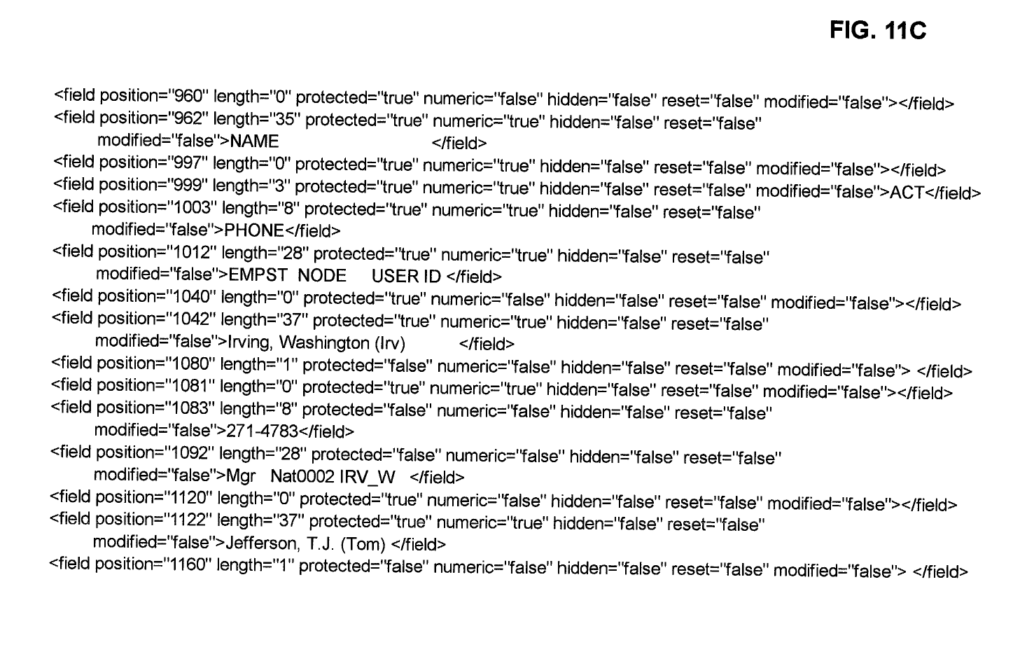

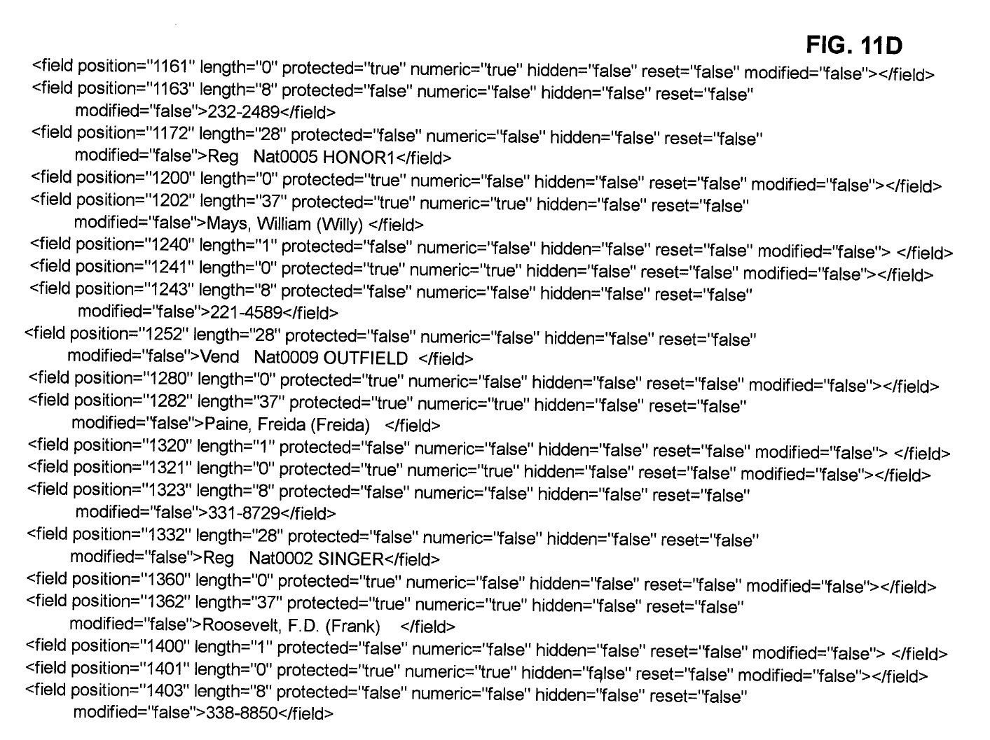

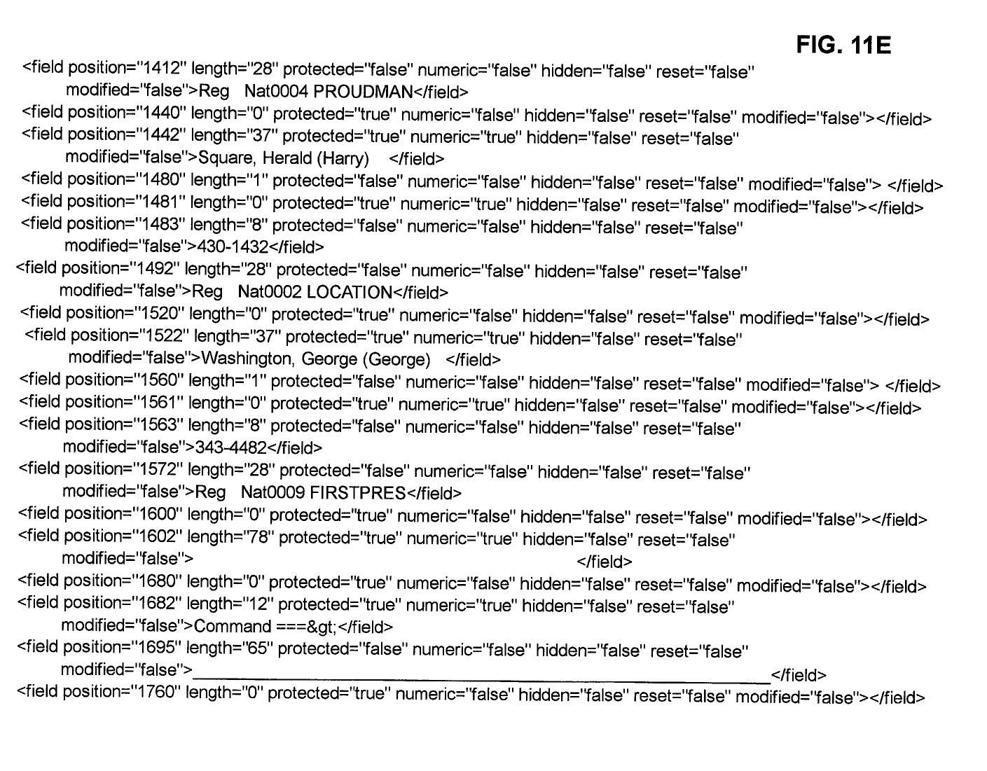

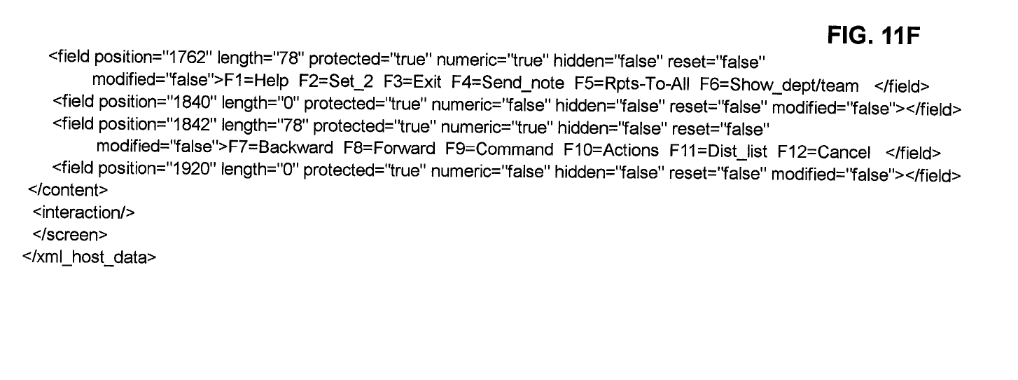

The sample XML document shown in FIG. 11 corresponds to the legacy host screen in FIG. 7. A structured document of this type may be exchanged, for example, between peer applications in order to convey legacy host data in a more modern computing environment. Complex data components may be extracted from structured documents using the above-described techniques of the present invention. The extracted components may then be used according to the needs of a particular environment, for example by restructuring the data into a format such as the GUI display shown in FIG. 8.

As has been described, the present invention provides improved techniques for extracting complex data components from data streams. The disclosed techniques enable users without programming skills to easily develop customized rules for data extraction. The rules can be modified by the user as required, without requiring access to application program source code. Furthermore, the disclosed techniques specify creation of the extracted data as documents in an extensible markup language, which can be easily and efficiently transformed into other notations and/or other formats without re-touching the source of the data stream (e.g. without having to re-contact a legacy host application). As an example of transforming the extracted data into another notation, it may be desirable in a particular environment to create documents in other markup languages which may be better suited to a particular recipient of the data (such as HTML or WML, as previously discussed). As an example of transforming the extracted data into another format, it may be desirable to reposition data extracted from a legacy host screen for presentation on a modern GUI screen (such as the example shown in FIG. 8). One or more style sheets may be applied for this purpose. Another type of transformation that may be performed is to translate extracted text strings into another natural language. Many other types of transformations may be to efficiently performed once the data has been extracted and stored using a well-defined notation such as XML.

While the preferred embodiment of the present invention has been described, additional variations and modifications in that embodiment may occur to those skilled in the art once they learn of the basic inventive concepts. Therefore, it is intended that the appended claims shall be construed to include both the preferred embodiment and all such variations and modifications as fall within the spirit and scope of the invention.

What is claimed is:

1. A computer program product for efficiently extracting data from a data stream, the computer program product embodied on one or more computer-readable media and comprising:
computer-readable program code means for defining one or more data extraction rules, each of the rules comprising one or more rule components;
computer-readable program code means for defining one or more output document templates for storing extracted data, wherein each of the templates comprises one or more tags which are hierarchically structured and wherein each template is to be associated with one or more of the data extraction rules;
computer-readable program code means for associating at least one of the templates with at least one of the rules;
computer-readable program code means for storing the rules, the templates, and the associations;
computer-readable program code means for monitoring at least one data stream for arrival of incoming data;
computer-readable program code means for comparing the incoming data to selected ones of the stored rules until detecting a matching rule;
computer-readable program code means for extracting data from the incoming data, upon detecting the matching rule, according to the matching rule; and
computer-readable program code means for storing the extracted data in an extensible document which is created according to the tags and structure of a selected one of the templates that is associated with the matching rule.

2. The computer program product according to claim 1, wherein the computer-readable program code means for associating further comprises computer-readable program code means for associating the rule components of a particular rule with the tags of a particular template.

3. The computer program product according to claim 1, further comprising computer-readable program code means for transforming the extracted data in the extensible document into another notation.

4. The computer program product according to claim 1, further comprising computer-readable program code means for transforming the extracted data in the extensible document into another format.

5. The computer program product according to claim 1, wherein the extensible document is an Extensible Markup Language (“XML”) document.

6. The computer program product according to claim 1, wherein the components of selected ones of the rules specify textual patterns.

7. The computer program product according to claim 1, wherein the components of selected ones of the rules specify data element and attribute patterns.

8. The computer program product according to claim 1, wherein the components of selected ones of the rules specify a combination of textual patterns and data element and attribute patterns.

9. A system for efficiently extracting data from a data stream, comprising:
means for defining one or more data extraction rules, each of the rules comprising one or more rule components;
means for defining one or more output document templates for storing extracted data, wherein each of the templates comprises one or more tags which are hierarchically structured and wherein each template is to be associated with one or more of the data extraction rules;
means for associating at least one of the templates with at least one of the rules;
means for storing the rules, the templates, and the associations;
means for monitoring at least one data stream for arrival of incoming data;
means for comparing the incoming data to selected ones of the stored rules until detecting a matching rule;
means for extracting data from the incoming data, upon detecting the matching rule, according to the matching rule; and
means for storing the extracted data in an extensible document which is created according to the tags and structure of a selected one of the templates that is associated with the matching rule.

10. The system according to claim 9, wherein the means for associating further comprises means for associating the rule components of a particular rule with the tags of a particular template.

11. The system according to claim 9, further comprising means for transforming the extracted data in the extensible document into another notation.

12. The system according to claim 9, further comprising means for transforming the extracted data in the extensible document into another format.

13. The system according to claim 9, wherein the extensible document is an Extensible Markup Language (“XML”) document.

14. The system according to claim 9, wherein the components of selected ones of the rules specify textual patterns.

15. The system according to claim 9, wherein the components of selected ones of the rules specify data element and attribute patterns.

16. The system according to claim 9, wherein the components of selected ones of the rules specify a combination of textual patterns and data element and attribute patterns.

17. A method for efficiently extracting data from a data stream comprising the steps of. defining one or more data extraction rules, each of the rules comprising one or more rule components;
defining one or more output document templates for storing extracted data, wherein each of the templates comprises one or more tags which are hierarchically structured and wherein each template is to be associated with one or more of the data extraction rules;
associating at least one of the templates with at least one of the rules;
storing the rules, the templates, and the associations;
monitoring at least one data stream for arrival of incoming data;
comparing the incoming data to selected ones of the stored rules until detecting a matching rule;
extracting data from the incoming data, upon detecting the matching rule, according to the matching rule; and
storing the extracted data in an extensible document which is created according to the tags and structure of a selected one of the templates that is associated with the matching rule.

18. The method according to claim 17, wherein the associating step further comprises the step of associating the rule components of a particular rule with the tags of a particular template.

19. The method according to claim 17, further comprising the step of transforming the extracted data in the extensible document into another notation.

20. The method according to claim 17, further comprising the step of transforming the extracted data in the extensible document into another format.

21. The method according to claim 17, wherein the extensible document is an Extensible Markup Language (“XML”) document.

22. The method according to claim 17, wherein the components of selected ones of the rules specify textual patterns.

23. The method according to claim 17, wherein the components of selected ones of the rules specify data element and attribute patterns.

24. The method according to claim 17, wherein the components of selected ones of the rules specify a combination of textual patterns and data element and attribute patterns.

25. The method according to claim 17, wherein the data stream is a legacy host stream containing one or more presentation spaces.

26. The method according to claim 17, wherein the data stream is sent between peer applications.

27. The method according to claim 26, wherein the data stream contains one or more Extensible Markup Language (“XML”) documents.

28. The method according to claim 17, wherein the data stream contains one or more Web pages.
